(19) United States
(12) Patent Application Publication
(10) Pub. No.: US 2026/0210775 A1
(43) Pub. Date: Jul. 23, 2026

(54) DETERMINING PROCESS CHAMBER COMPONENT TEMPERATURES

(71) Applicant: Lam Research Corporation, Fremont, CA (US)

(72) Inventor: Noah Elliot Baker, West Linn, OR (US)

(21) Appl. No.: 19/139,064

(22) PCT Filed: Dec. 13, 2023
(86) PCT No.: PCT/US2023/083810

§ 371 Date: Jun. 13, 2025

Related U.S. Application Data
(60) Provisional application No. 63/387,762, filed on Dec. 16, 2022.

(51) Int. Cl. G01K 7/32; G01K 1/14

(52) U.S. Cl. CPC G01K 7/32; G01K 1/14

(57) ABSTRACT

Methods and systems for determining temperatures are provided. In some embodiments, a method for determining temperatures comprises applying an input signal to a first conductive element of a fabrication apparatus, the input signal having a first magnitude and a first phase. The method may comprise measuring an output signal at a second conductive element of the fabrication apparatus, the output signal having a second magnitude and a second phase. The method may comprise determining a temperature of a region between the first conductive element and the second conductive element based at least in part on the second magnitude and the second phase.

### INCORPORATION BY REFERENCE

A PCT Request Form is filed concurrently with this specification as part of the present application. Each application that the present application claims benefit of or priority to as identified in the concurrently filed PCT Request Form is incorporated by reference herein in its entirety.

### BACKGROUND

It is important to accurately determine the temperatures of various components of a process chamber. For example, accurate temperature measurements may enable more granular control of a semiconductor fabrication process. However, it can be difficult to obtain accurate temperature measurements, particularly when a process chamber is in use.

The background description provided herein is for the purposes of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Methods and systems for determining process chamber component temperatures are provided. In some embodiments, a method for determining temperatures comprises: (a) applying an input signal to a first conductive element of a fabrication apparatus, the input signal having a first magnitude and a first phase; (b) measuring an output signal at a second conductive element of the fabrication apparatus, the output signal having a second magnitude and a second phase; and (c) determining a temperature of a region between the first conductive element and the second conductive element based at least in part on the second magnitude and the second phase.

In some examples, the first conductive element and/or the second conductive element comprises at least one of: an electrode configured to provide electrostatic clamping for a wafer undergoing processing in the fabrication apparatus; an electrode configured to provide a path for radio frequency (RF) coupling to a plasma; a wafer undergoing processing; or a heater filament.

In some examples, the input signal is within a predetermined range of a resonance frequency of a circuit formed by the first conductive element and the second conductive element. In some examples, the resonance frequency is determined at least in part by an inductance of an inductor in series with the first conductive element or the second conductive element. In some examples, determining the temperature of the region comprises utilizing a difference between at least one of: the second magnitude and the first magnitude; and the second phase and the first phase. In some examples, the difference is provided as an input to a function configured to output the temperature based on the difference.

In some examples, the method further comprises: repeating (a) and (b) until a determination that the input signal is within a predetermined range of a resonance frequency of a circuit formed by the first conductive element and the second conductive element is made, wherein the determination is based at least in part on the second magnitude and the second phase associated with a given output signal; and determining the temperature of the region based at least in part on the resonance frequency.

In some examples, the method further comprises repeating (a)-(c) for at least two other conductive elements corresponding to at least one other region between the at least two other conductive elements.

In some examples, the first conductive element and/or the second conductive element is embedded in a component of the fabrication apparatus.

In some examples, the first conductive element and/or the second conductive element is affixed to a portion of the fabrication apparatus.

In some embodiments, an apparatus comprises: a signal generator configured to apply an input signal to a first conductive element of a fabrication apparatus, the input signal having a first magnitude and a first phase; and measurement circuitry. The measurement circuitry may be configured to: measure an output signal at a second conductive element of the fabrication apparatus, the output signal having a second magnitude and a second phase; and determine a temperature of a region between the first conductive element and the second conductive element based at least in part on the second magnitude and the second phase.

In some examples, the first conductive element and/or the second conductive element comprises at least one of: an electrode configured to provide electrostatic clamping for a wafer undergoing processing in the fabrication apparatus; an electrode configured to provide a path for radio frequency (RF) coupling to a plasma; a wafer undergoing processing; or a heater filament.

In some examples, the input signal is within a predetermined range of a resonance frequency of a circuit formed by the first conductive element and the second conductive element. In some examples, the resonance frequency is determined at least in part by an inductance of an inductor in series with the first conductive element or the second conductive element. In some examples, determining the temperature comprises utilizing a difference between at least one of: the second magnitude and the first magnitude; and the second phase and the first phase. In some examples, the difference is provided as an input to a function configured to output the temperature based on the difference.

In some examples, the first conductive element and/or the second conductive element is embedded in a component of the fabrication apparatus. In some examples, the component in which the first conductive element or the second conductive element is embedded comprises ceramic.

In some examples, the first conductive element and/or the second conductive element is affixed to a portion of the fabrication apparatus.

### BRIEF DESCRIPTION OF THE DRAWINGS

FIGS. 1A-1I illustrate example configurations of process chamber components and regions in which temperature is measured in accordance with some embodiments.

FIG. 2 is a schematic diagram of a circuit representing components of a process chamber in accordance with some embodiments.

FIG. 3 is a schematic diagram of a circuit representing components of a process chamber in accordance with some embodiments.

FIG. 4 is a graph of example phase responses at various temperatures in accordance with some embodiments.

FIG. 5 is a graph of example magnitude responses at various temperatures in accordance with some embodiments.

FIG. 6 is a flowchart of an example process for determining temperature of a region between two conductive elements in accordance with some embodiments.

FIG. 7 presents an example computer system that may be employed to implement certain embodiments described herein.

### DETAILED DESCRIPTION

In the following description, numerous specific details are set forth to provide a thorough understanding of the presented embodiments. The disclosed embodiments may be practiced without some or all of these specific details. In other instances, well-known process operations have not been described in detail to not unnecessarily obscure the disclosed embodiments. While the disclosed embodiments will be described in conjunction with the specific embodiments, it will be understood that it is not intended to limit the disclosed embodiments.

It may be useful to measure the temperature of various components of a fabrication system. Example components may include a pedestal on which a wafer undergoing processing rests, a gas line heater within a chamber, the chamber walls, or the like. However, it may be difficult to accurately measure the temperature of the component, particularly during operation of the fabrication system. For example, temperature may conventionally be measured using a thermocouple or other similar element. However, there are limitations to use of a thermocouple or other similar measurement element. For example, in the case of a pedestal, a thermocouple may be used to measure the temperature of a heating element embedded in or affixed to the pedestal that serves to heat the pedestal. However, the thermocouple may be configured to measure the temperature of the heating element. Depending on the material of the pedestal, the temperature of the heating element may be substantially different from the temperature of the pedestal. For example, the temperature difference may be substantial for the case of a ceramic pedestal due to heat conductivity properties of ceramic. As another example, a thermocouple may not be able to measure the temperature of various components (e.g., a gas line heater) within a process station or chamber that become “RF hot” during operation of the apparatus. Because a fabrication system control system may utilize inferred temperatures of various system components, control of the fabrication system, and therefore, control of the fabrication process itself, may be suboptimal when temperature of the components cannot be accurately measured.

Disclosed herein are systems, methods, and techniques for determining temperature of process chamber components. In particular, an input signal may be applied to a first conductive element, and an output signal may be measured at a second conductive element. Magnitude and phase characteristics of the output signal may be used to determine a temperature of a region between the first conductive element and the second conductive element. In particular, because the impedance of the region between the first conductive element and the second conductive element may change as a function of temperature of the region, measuring the characteristics of the output signal may implicitly indicate the impedance of the region, which may therefore be used to determine a temperature of the region. Note that the first conductive element and/or the second conductive element may each be one of: a heating element, an electrode, an external component affixed to a component such as a pedestal, a wafer or substrate being processed, or the like.

In some embodiments, the input signal may be provided at a frequency that is at or near a resonant frequency of a circuit defined by the first conductive element, the second conductive element, and the region between the first conductive element and the second conductive element. The resonant frequency may be achieved and/or be dependent on an inductance of an inductor that is in series with the first conductive element or the second conductive element. Because the impedance of the region may change substantially as a function of temperature when the input signal is at or near the resonance frequency, by operating at the resonance frequency, large changed in temperature may be characterized using difference between the input signal and the output signal.

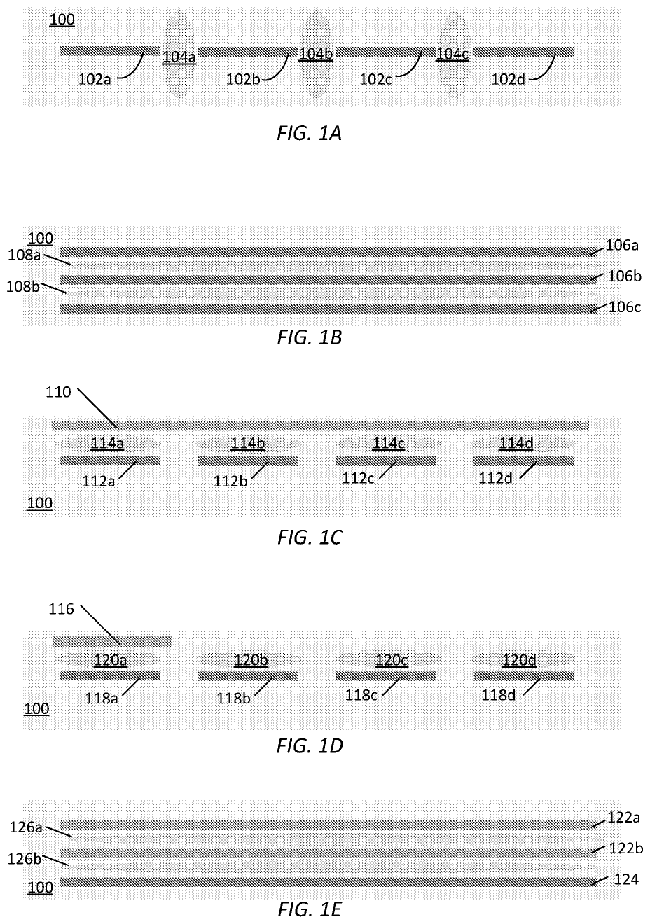

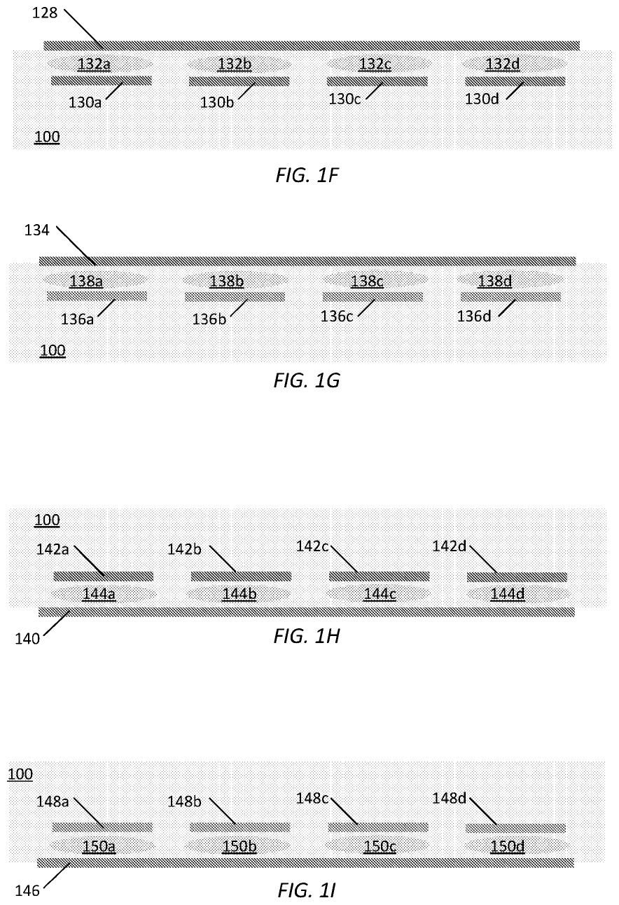

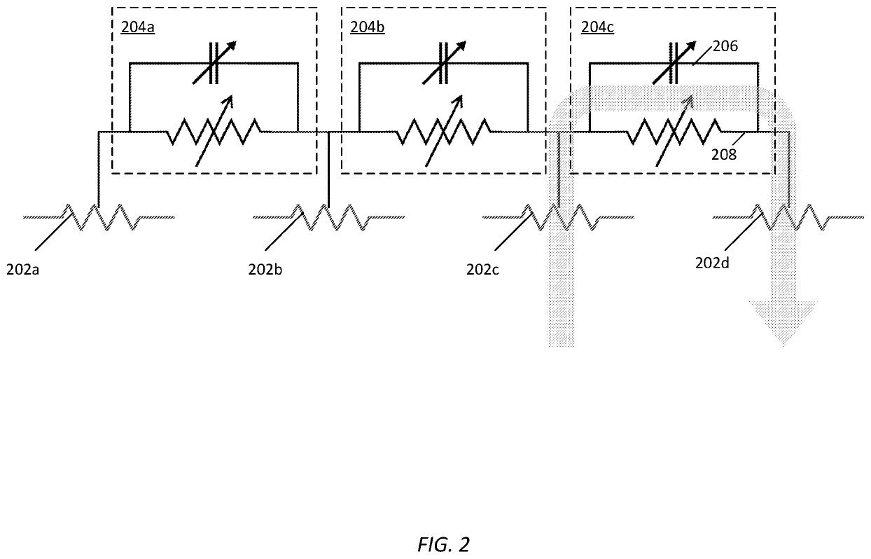

FIGS. 1A-1I illustrate various configurations of conductive elements and regions in which temperature may be measured according to some embodiments. Each of the conductive elements in FIGS. 1A-1I are embedded within a ceramic body 100 or affixed to an external portion of ceramic body 100. Ceramic body 100 may be, e.g., a ceramic pedestal in a process station or chamber. The temperature regions depicted in FIGS. 1A-1I may be measured using the techniques described herein, e.g., as shown in and described below in connection with FIGS. 2, 3, and 6.

FIG. 1A illustrates a configuration of four horizontally distributed heater elements (e.g., heater elements 102a, 102b, 102c, and 102d). Temperature may be determined using the techniques described herein between each pair of heater elements. For example, temperature may be determined at regions 104a, 104b, and 104c, each of which is between two heater elements.

FIG. 1B illustrates a configuration of three vertically distributed heater elements (e.g., heater elements 106a, 106b, and 106c). Temperature may be determined using the techniques described herein between each pair of heater elements. For example, temperature may be determined at regions 108a and 108b.

FIG. 1C illustrates a configuration that includes an electrode 110. For example, electrode 110 may be used to provide electrostatic clamping for a wafer undergoing processing. The configuration also includes four horizontally distributed heater elements (e.g., heater elements 112a, 112b, 112c, and 112d). As illustrated in FIG. 1C, temperature may be determined at regions between each heater element and electrode 110. For example, temperature may be determined at regions 114a, 114b, 114c, and 114d. Although not illustrated in FIG. 1C, in some embodiments, temperature may be determined at regions between the heater elements, e.g., between heater element 112a and heater element 112b.

FIG. 1D is similar to FIG. 1C, and includes four horizontally distributed heater elements, 118a, 118b, 118c, and 118d. Unlike FIG. 1C, electrode 116 occupies a smaller region of ceramic body 100. Temperature may be determined at regions 120a, 120b, 120c, and 120d.

FIG. 1E illustrates two electrodes (122a and 122b) and a heater element (124) distributed vertically in ceramic body 100. Temperature may be determined at regions between each conductive element, e.g., at regions 126a and/or 126b.

In some embodiments, a wafer or substrate (e.g., a wafer or substrate undergoing processing) may be considered a conductive element. FIG. 1F illustrates a configuration in which a wafer 128 is placed on a top portion of ceramic body 100 (e.g., a ceramic pedestal). Horizontally distributed heater elements 130a, 130b, 130c, and 130d are embedded within ceramic body 100. Temperature may be determined at regions between each heater element and wafer 128, e.g., at regions 132a, 132b, 132c, and 132d.

FIG. 1G illustrates a configuration that includes a wafer or substrate 134 (e.g., on a top portion of ceramic body 100) with horizontally distributed electrodes 136a, 136b, 136c, and 136d. Temperature may be determined at regions between a given electrode and the wafer, e.g., at regions 138a, 138b, 138c, and/or 138d.

In some implementations, a conductive element may be a component that is external to ceramic body 100. For example, FIG. 1H illustrates a configuration that includes an external component 140. The configuration of FIG. 1H includes horizontally distributed heater elements 142a, 142b, 142c, and 142d. Temperature may be determined at regions between a given heater element and external component 140, such as at regions 144a, 144b, 144c, and/or 144d.

FIG. 1I illustrates a configuration that includes an external component 146 and horizontally distributed electrodes 148a, 148b, 148c, and 148d. Temperature may be determined at regions between a given electrode and external component 146, such as at regions 150a, 150b, 150c, and/or 150d.

Note that the configurations shown in and described above in connection with FIGS. 1A-1I are merely exemplary. For example, in instances in which a given number of a particular conductive element is illustrated (e.g., four electrodes, four heater elements, one external component, etc.), this is merely an example, and other numbers of each element may be utilized.

As temperature, e.g., of a ceramic body, changes, the resistance and/or capacitance between conductive elements also changes. By measuring the changes in impedance, a determination of temperature in a region between two conductive elements may be determined. In some implementations, the changes in impedance may be characterized by applying an input signal to a first conductive element. The input signal may be a sinusoidal signal having a first magnitude and a first phase. An output signal may be measured at a second conductive element. The output signal may have a second magnitude and a second phase, where the impedance may be characterized based at least in part on the second magnitude and the second phase of the output signal.

FIG. 2 is a schematic circuit diagram that illustrates conductive elements in accordance with some embodiments. The circuit diagram illustrated in FIG. 2 may represent elements embedded in and/or affixed to a ceramic body (e.g., a ceramic pedestal), and/or portions internal to the ceramic body. As illustrated, the circuit diagram includes resistors 202a, 202b, 202c, and 202d, each of which represent a conductive element, such as a heater element. Temperature may be determined at regions 204a, 204b, and/or 204c, each region corresponding to a region between two conductive elements. Each temperature region is represented by a variable capacitor and a variable resistor in parallel (e.g., capacitor 206 and resistor 208). The capacitance and resistance associated with the variable capacitor and the variable resistor, respectively, may change as a function of temperature. In some implementations, a temperature of a given region (which may be internal to the ceramic body, e.g., a pedestal), may be determined by applying an input signal to one conductive element and characterizing an output signal obtained at another conductive element. By way of example, a temperature of region 204c may be determined by applying an input signal at a conductive element associated with resistor 202c or a conductive element associated with resistor 202d, and characterizing an output signal at the other conductive element of the pair.

In some implementations, a circuit that includes two conductive elements and a region (e.g., of a ceramic body, such as a ceramic pedestal) for which temperature may be determined may have a resonant frequency. The resonant frequency may be determined based at least in part on an inductor that is in series with either the first conductive element or the second conductive element. Characteristics of an output signal with respect to an input signal, when the circuit is operated at or close to the resonant frequency, may be used to determine the temperature of the region between the two conductive elements. As used herein, when an input signal is provided “at” a resonant frequency, the input signal may be at exactly the resonant frequency, or within a predetermined tolerance threshold of the resonant frequency, e.g., within +/−5% of the resonant frequency, within +/−10% of the resonant frequency, or the like.

In some implementations, the resonant frequency may be identified during, e.g., a calibration procedure and/or based on an inductance of the inductor placed in series with the first conductive element or the second conductive element. After the resonant frequency is identified, the input signal may be provided at the resonant frequency or within a predetermined tolerance range of the resonant frequency. The input signal may be a sinusoid having a given magnitude and a given phase. The output signal may be measured at the other conductive element of the pair of conductive elements. Differences in magnitude and/or phase information between the output signal and the input signal may be used to determine the temperature of the region between the conductive elements. For example, in some implementations, a difference between a magnitude of the output signal and a magnitude of the input signal may be used. Additionally or alternatively, in some implementations, a difference between a phase of the output signal and a phase of the input signal may be used. The difference(s) may be used as an input value to a function (e.g., a linear regression function, a polynomial regression function, an exponential regression function, etc.) that generates, as an output, a temperature of the region.

In other implementations, a series of input signals may be provided, each at a different frequency. For example, each input signal in the series of input signals may have a frequency that is larger relative to the preceding input signal, such that the series of input signals sweeps through a frequency range. Each input signal may have a given magnitude and phase. For each input signal, an output signal may be measured at the other conductive element of the pair of conductive elements. The resonant frequency may be identified based on the magnitude and phase of the output signals relative to the magnitude and phase of the corresponding input signals. For example, the resonant frequency (or a frequency sufficiently close to the resonant frequency) may be identified as the frequency of the input signal that generates an output signal having a magnitude and/or phase closest to that of the input signal (e.g., the output signal with the least attenuation relative to the input signal). In some such implementations, the temperature may be determined by using a function (e.g., a linear regression function, a polynomial regression function, an exponential regression function, or the like) that takes, as an input, the identified resonant frequency, and generates, as an output, the determined temperature of the region between the two conductive elements.

Note that, in instances in which a regression function is used to determine the temperature, coefficients of the regression function may be identified using a calibration procedure. The calibration procedure may involve measuring known temperatures (e.g., using one or more thermocouples, one or more infrared thermal sensors, a temperature coefficient of resistance (TCR), or the like) of a body. For example, the calibration procedure may involve heating the body to a known temperature and measuring the temperature (e.g., using one or more thermocouples) as the body cools. During the calibration procedure, input signals may be provided and output signals may be recorded in order to generate regression function coefficients that map the characteristics of the input signal and/or the output signal (e.g., magnitude differences, phase differences, or the like) to temperature.

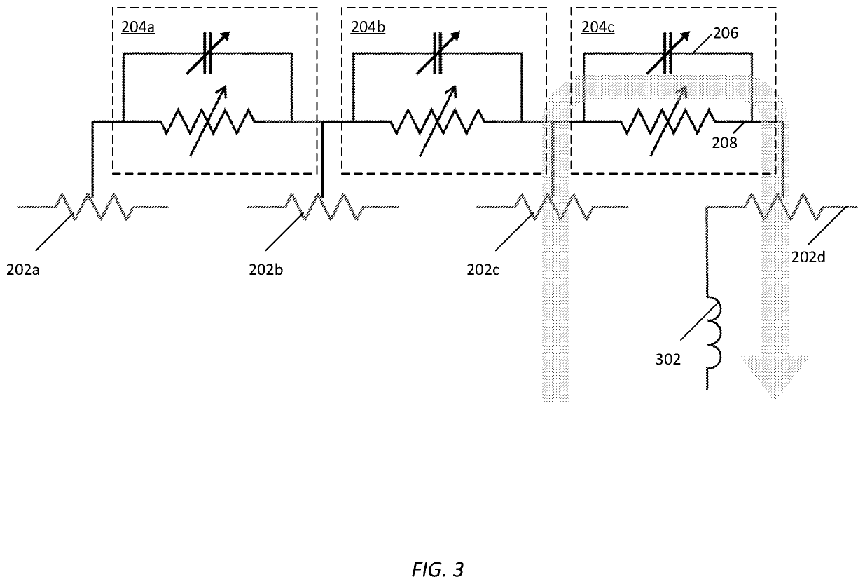

FIG. 3 is a schematic diagram of a circuit that has a resonant frequency which may be used to determine temperature in accordance with some embodiments. Similar to what is shown in and described above in connection with FIG. 2, four heating elements are horizontally distributed and represented by resistors 202a, 202b, 202c, and 202d. Unlike what is shown in FIG. 2, an inductor 302 is included in series with resistor 202d. Note that although inductor 302 is shown as in series with resistor 202d, in some implementations, inductor 302 may instead be in series with resistor 202c, and may still induce a resonance in the circuit formed by the heating elements represented by resistors 202c and 202d and region 204c. Additionally, in some implementations, multiple inductors (e.g., two, three, five, etc.) may be used. As described above in connection with FIG. 2, an input signal may be applied at heating element 202c, and an output signal may be obtained at inductor 302 (which is in series with heating element 202d). Note that although resistors 202a-202d are described as representing heating elements, in other embodiments, resistors 202a-202d may each represent any other suitable conductive element, such as an electrode, a wafer or a substrate, etc.

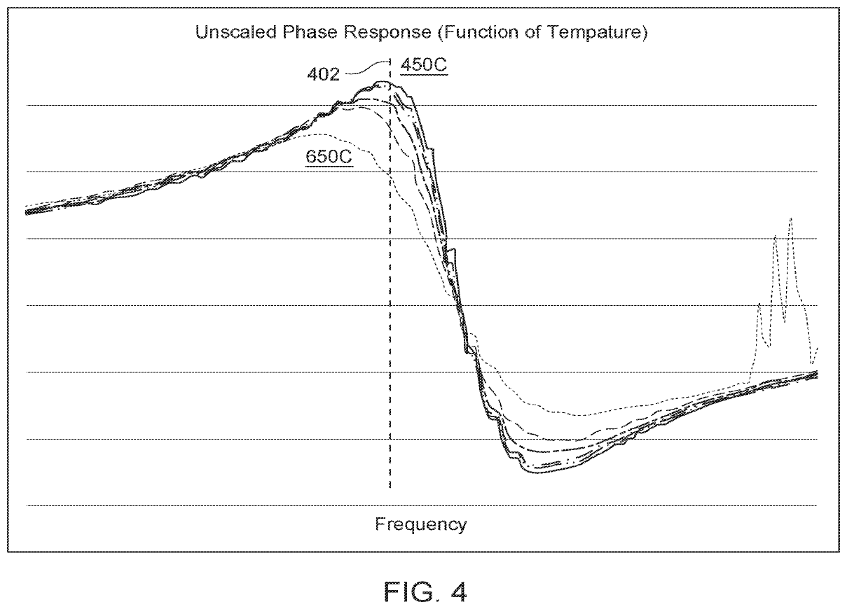

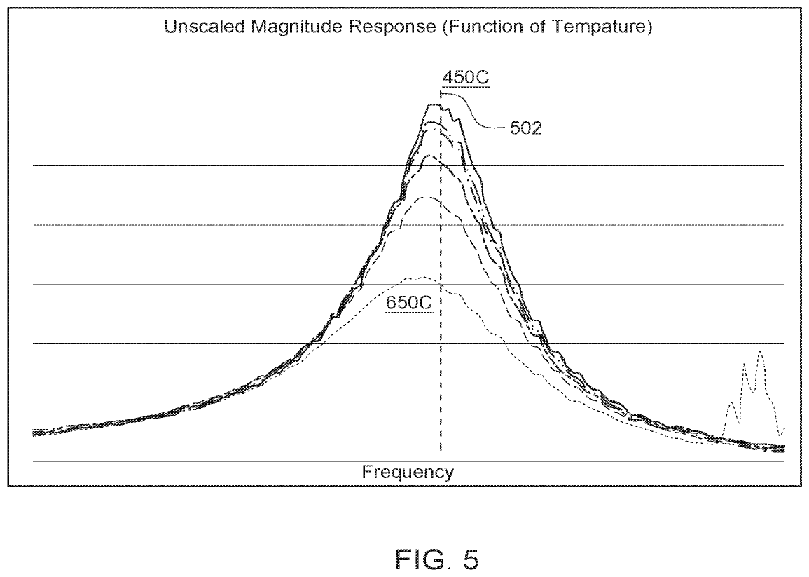

FIGS. 4 and 5 illustrate the effect of temperature on magnitude and phase of an output signal. For example, FIG. 4 illustrates unscaled phase of an output signal as a function of input signal frequency. Each curve depicted in FIG. 4 corresponds to a different temperature of the ceramic body. The resonant frequency is depicted by dashed line 402. Note that the x-axis and the y-axis are in unscaled units, and accordingly, the resonance frequency of the system represented in FIG. 4 is a scaled version of the frequency corresponding to dashed line 402. By utilizing input signals at or within a predetermined range of the resonant frequency, the changes in the phase response for output signals with respect to the corresponding input signals may be maximized, thereby allowing more granular determinations in the temperature of the region.

FIG. 5 illustrates unscaled magnitude of an output signal as a function of input signal frequency. Each curve depicted in FIG. 5 corresponds to a different temperature of the ceramic body. The resonant frequency is depicted by dashed line 502. Note that the x-axis is in unscaled units, and accordingly, the resonance frequency of the system represented din FIG. 5 is a scaled version of the frequency corresponding to dashed line 502. By utilizing input signals at or within a predetermined range of the resonant frequency, the changes in the magnitude response for output signals with respect to the corresponding input signals may be maximized, thereby allowing more granular determinations in the temperature of the region.

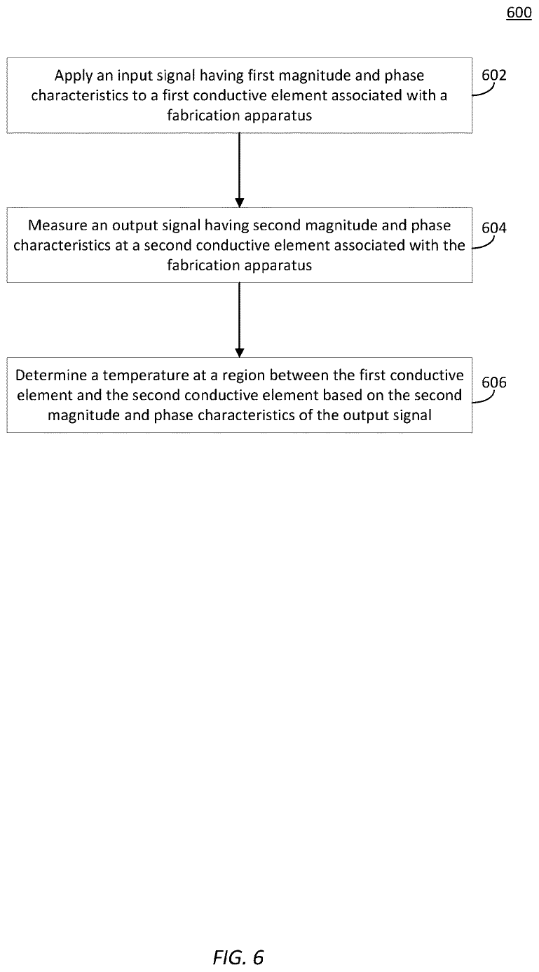

FIG. 6 is a flowchart of an example process 600 for determining a temperature of a region in accordance with some embodiments. As illustrated, blocks of process 600 may be executed by a processor or a controller associated with a fabrication apparatus. In some embodiments, blocks of process 600 may be executed in an order other than what is shown in FIG. 6. In some implementations, two or more blocks of process 600 may be executed substantially in parallel. In some embodiments, one or more blocks of process 600 may be omitted.

Process 600 can begin at 602 by applying an input signal having first magnitude and phase characteristics to a first conductive element associated with a fabrication apparatus. The first conductive element may be a heating element, an electrode, a wafer or substrate, or the like. The first conductive element may be disposed in (e.g., embedded within) a body, such as a pedestal of a station or chamber. In some embodiments, the body may be a ceramic body. In some implementations, the first conductive element may be affixed to or rest on an outer portion of the body. Note that the temperature may be determined (e.g., as described below in connection with block 606) for a portion of the body.

As described above, the input signal may be a sinusoidal signal. In some implementations, the input signal may be at a frequency that is at or near a resonant frequency of the system defined by the first conductive element, a second conductive element, and a portion of the body between the first conductive element and the second conductive element.

At 604, process 600 can measure an output signal having second magnitude and phase characteristics at a second conductive element associated with the fabrication apparatus. Similar to what is described above in connection with block 604, the second conductive element may be a heating element, an electrode, a wafer or substrate, or the like. The second conductive element may be disposed in (e.g., embedded within) a body, such as a pedestal. Note that the first conductive element and the second conductive element may be of the same type (e.g., electrodes, heating elements, etc.) or of different types (e.g., an electrode and a heating element, an electrode and a wafer, or the like).

At 606, process 600 can determine a temperature at a region between the first conductive element and the second conductive element based on the second magnitude and phase characteristics of the output signal. For example, in some implementations, process 600 can determine a difference between the magnitude associated with the output signal and the magnitude associated with the input signal, and can use the difference to determine the temperature. Additionally or alternatively, in some implementations, process 600 can determine a difference between the phase associated with the output signal and the phase associated with the input signal, and can use the difference to determine the temperature. In some embodiments, the temperature may be determined by utilizing a difference between the magnitude of the output signal and the magnitude of the input signal and/or a difference between the phase of the output signal and the phase of the input signal as one or more input values of a regression function. The regression function may generate, as an output, the temperature of the region. The regression function may be a linear regression, a polynomial regression, an exponential regression, or the like. In some embodiments, coefficients of the regression function may be determined using a calibration procedure. For example, the calibration procedure may involve measuring the temperature of a body using one or more thermocouples while concurrently providing input signals and characterizing output signals at the different temperatures. Characteristics of the input signals and the output signals may be used in conjunction with the measured temperatures to determine coefficients of the regression function once the calibration procedure has been completed.

Note that, in some implementations, rather than providing an input signal at block 604 at or near the resonant frequency, the resonant frequency may be identified by providing a series of input signals, each at a different frequency, and measuring magnitude and phase characteristics of the corresponding output frequencies. In some such implementations, rather than using differences between the magnitude and/or the phase of the output signal at the resonant frequency, the value of the identified frequency itself may be used to determine the temperature at 606. For example, the value of the identified resonant frequency may be used as an input value of a regression function that generates, as an output, the determined temperature.

Additionally, it should be noted that, in some implementations, process 600 may be repeated for multiple pairs of conductive elements such that a temperature may be determined for a region between each pair of conductive elements. In one example, for a pedestal having, e.g., four embedded heating elements, process 600 may be repeated three times (e.g., for each pairwise combination of the four heating elements) to determine three corresponding temperature regions. Moreover, in some embodiments, process 600 may be repeated at different time points to, e.g., characterize how the temperature of the body changes over time (e.g., as a pedestal is heated, as a fabrication process is performed, etc.).

### Context for Disclosed Computational Embodiments

Systems including fabrication tools as described herein may include logic for automated control of components.

The analysis logic may be designed and implemented in any of various ways. For example, the logic can be implemented in hardware and/or software. Examples are presented in the controller section herein. Hardware-implemented control logic may be provided in any of a variety of forms, including hard coded logic in digital signal processors, application-specific integrated circuits, and other devices that have algorithms implemented as hardware. Analysis logic may also be implemented as software or firmware instructions configured to be executed on a general-purpose processor. System control software may be provided by “programming” in a computer readable programming language.

The computer program code for controlling processes in a process sequence can be written in any conventional computer readable programming language: for example, assembly language, C, C++, Pascal, Fortran, or others. Compiled object code or script is executed by the processor to perform the tasks identified in the program. Also as indicated, the program code may be hard coded.

Integrated circuits used in logic may include chips in the form of firmware that store program instructions, digital signal processors (DSPs), chips defined as application specific integrated circuits (ASICs), and/or one or more microprocessors, or microcontrollers that execute program instructions (e.g., software). Program instructions may be instructions communicated in the form of various individual settings (or program files), defining operational parameters for carrying out a particular analysis or image analysis application.

In some implementations, the image analysis logic is resident (and executes) on a computational resource on or closely associated with a fabrication tool, e.g., associated with conductive elements and/or regions for which temperature is determined. For example, such analysis logic may receive magnitude and/or phase information associated with a measured output signal and may determine temperature of a region of the fabrication tool based on the received magnitude and/or phase information.

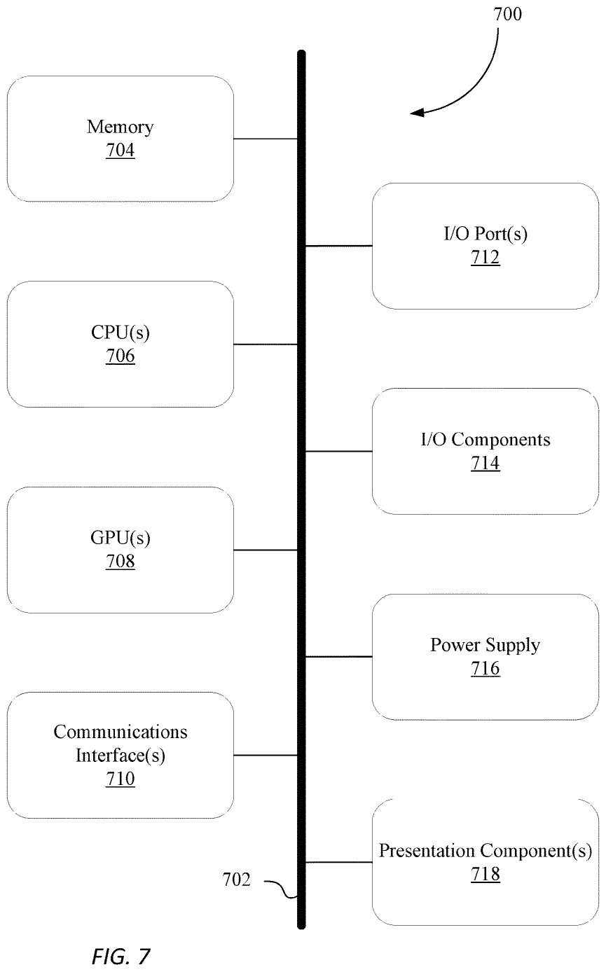

FIG. 7 is a block diagram of an example of the computing device 700 suitable for use in implementing some embodiments of the present disclosure. For example, device 700 may be suitable for implementing some or all functions of image analysis logic disclosed herein.

Computing device 700 may include a bus 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, and one or more presentation components 718 (e.g., display(s)). In addition to CPU 706 and GPU 708, computing device 700 may include additional logic devices that are not shown in FIG. 7, such as but not limited to an image signal processor (ISP), a digital signal processor (DSP), an ASIC, an FPGA, or the like.

Although the various blocks of FIG. 7 are shown as connected via the bus 702 with lines, this is not intended to be limiting and is for clarity only. For example, in some embodiments, a presentation component 718, such as a display device, may be considered an I/O component 714 (e.g., if the display is a touch screen). As another example, CPUs 706 and/or GPUs 708 may include memory (e.g., the memory 704 may be representative of a storage device in addition to the memory of the GPUs 708, the CPUs 706, and/or other components). In other words, the computing device of FIG. 7 is merely illustrative. Distinction is not made between such categories as “workstation,” “server,” “laptop,” “desktop,” “tablet,” “client device,” “mobile device,” “hand-held device,” “electronic control unit (ECU),” “virtual reality system,” and/or other device or system types, as all are contemplated within the scope of the computing device of FIG. 7.

Bus 702 may represent one or more busses, such as an address bus, a data bus, a control bus, or a combination thereof. The bus 702 may include one or more bus types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus.

Memory 704 may include any of a variety of computer-readable media. The computer-readable media may be any available media that can be accessed by the computing device 700. The computer-readable media may include both volatile and nonvolatile media, and removable and non-removable media. By way of example, and not limitation, the computer-readable media may comprise computer-storage media and/or communication media.

The computer-storage media may include both volatile and nonvolatile media and/or removable and non-removable media implemented in any method or technology for storage of information such as computer-readable instructions, data structures, program modules, and/or other data types. For example, memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. As used herein, computer storage media does not comprise signals per se.

The communication media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the communication media may include wired media such as a wired network or direct-wired connection, and wireless media such as acoustic, RF, infrared and other wireless media. Combinations of any of the above should also be included within the scope of computer-readable media.

CPU(s) 706 may be configured to execute the computer-readable instructions to control one or more components of the computing device 700 to perform one or more of the methods and/or processes described herein. CPU(s) 706 may each include one or more cores (e.g., one, two, four, eight, twenty-eight, seventy-two, etc.) that are capable of handling a multitude of software threads simultaneously. CPU(s) 706 may include any type of processor and may include different types of processors depending on the type of computing device 700 implemented (e.g., processors with fewer cores for mobile devices and processors with more cores for servers). For example, depending on the type of computing device 700, the processor may be an ARM processor implemented using Reduced Instruction Set Computing (RISC) or an x86 processor implemented using Complex Instruction Set Computing (CISC). Computing device 700 may include one or more CPUs 706 in addition to one or more microprocessors or supplementary co-processors, such as math co-processors.

GPU(s) 708 may be used by computing device 700 to render graphics (e.g., 3D graphics). GPU(s) 708 may include many (e.g., tens, hundreds, or thousands) of cores that are capable of handling many software threads simultaneously. GPU(s) 708 may generate pixel data for output images in response to rendering commands (e.g., rendering commands from CPU(s) 706 received via a host interface). GPU(s) 708 may include graphics memory, such as display memory, for storing pixel data. The display memory may be included as part of memory 704. GPU(s) 708 may include two or more GPUs operating in parallel (e.g., via a link). When combined, each GPU 708 can generate pixel data for different portions of an output image or for different output images (e.g., a first GPU for a first image and a second GPU for a second image). Each GPU can include its own memory or can share memory with other GPUs.

In examples where the computing device 700 does not include the GPU(s) 708, the CPU(s) 706 may be used to render graphics.

Communication interface 710 may include one or more receivers, transmitters, and/or transceivers that enable computing device 700 to communicate with other computing devices via an electronic communication network, included wired and/or wireless communications. Communication interface 710 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet), low-power wide-area networks (e.g., LoRaWAN, SigFox, etc.), and/or the internet.

I/O ports 712 may enable the computing device 700 to be logically coupled to other devices including I/O components 714, presentation component(s) 718, and/or other components, some of which may be built in to (e.g., integrated in) computing device 700. Illustrative I/O components 714 include a microphone, mouse, keyboard, joystick, track pad, satellite dish, scanner, printer, wireless device, etc. I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of computing device 700. Computing device 700 may be include depth cameras, such as stereoscopic camera systems, infrared camera systems, RGB camera systems, touchscreen technology, and combinations of these, for gesture detection and recognition. Additionally, computing device 700 may include accelerometers or gyroscopes (e.g., as part of an inertia measurement unit (IMU)) that enable detection of motion. In some examples, the output of the accelerometers or gyroscopes may be used by computing device 700 to render immersive augmented reality or virtual reality.

Power supply 716 may include a hard-wired power supply, a battery power supply, or a combination thereof. Power supply 716 may provide power to computing device 700 to enable the components of computing device 700 to operate.

Presentation component(s) 718 may include a display (e.g., a monitor, a touch screen, a television screen, a heads-up-display (HUD), other display types, or a combination thereof), speakers, and/or other presentation components. Presentation component(s) 718 may receive data from other components (e.g., GPU(s) 708, CPU(s) 706, etc.), and output the data (e.g., as an image, video, sound, etc.).

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

### Additional Considerations

Without limitation, example systems may include a plasma etch chamber or module, a plasma-assisted deposition chamber or module such as a plasma-assisted chemical vapor deposition (PECVD) chamber or module or a plasma-assisted atomic layer deposition (PEALD) chamber or module, an atomic layer etch (ALE) chamber or module, a clean chamber or module, a physical vapor deposition (PVD) chamber or module, an ion implantation chamber or module, and any other plasma-assisted semiconductor processing systems that may be associated or used in the fabrication and/or manufacturing of semiconductor wafers.

Unless otherwise specified, the plasma power levels and associated parameters provided herein are appropriate for processing a 300 mm wafer substrate. One of ordinary skill in the art would appreciate that these parameters may be adjusted as necessary for substrates of other sizes.

The apparatus/process described herein may be used in conjunction with lithographic patterning tools or processes, for example, for the fabrication or manufacture of electronic devices including semiconductor devices, displays, LEDs, photovoltaic panels and the like. Typically, though not necessarily, such tools/processes will be used or conducted together in a common fabrication facility. Lithographic patterning of a film typically includes some or all of the following operations, each operation enabled with a number of possible tools: (1) application of photoresist on a workpiece, i.e., substrate, using a spin-on or spray-on tool; (2) curing of photoresist using a hot plate or furnace or UV curing tool; (3) exposing the photoresist to visible or UV or x-ray light with a tool such as a wafer stepper; (4) developing the resist so as to selectively remove resist and thereby pattern it using a tool such as a wet bench; (5) transferring the resist pattern into an underlying film or workpiece by using a dry or plasma-assisted etching tool; and (6) removing the resist using a tool such as an RF or microwave plasma resist stripper.

As used in this specification and appended claims, the singular forms “a”, “an”, and “the” include plural referents unless the content and context dictates otherwise. For example, reference to “a cell” includes a combination of two or more such cells. Unless indicated otherwise, an “or” conjunction is used in its correct sense as a Boolean logical operator, encompassing both the selection of features in the alternative (A or B, where the selection of A is mutually exclusive from B) and the selection of features in conjunction (A or B, where both A and B are selected).

It is to be understood that the phrases “for each <item> of the one or more <items>,” “each <item> of the one or more <items>,” or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite the fact that dictionary definitions of “each” frequently define the term to refer to “every one of two or more things”) and would not imply that there must be at least two of those items. Similarly, the term “set” or “subset” should not be viewed, in itself, as necessarily encompassing a plurality of items—it will be understood that a set or a subset can encompass only one member or multiple members (unless the context indicates otherwise).

The use, if any, of ordinal indicators, e.g., (a), (b), (c) . . . or the like, in this disclosure and claims is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated) unless indicated otherwise. For example, if step (ii) involves the handling of an element that is created in step (i), then step (ii) may be viewed as happening at some point after step (i). Similarly, if step (i) involves the handling of an element that is created in step (ii), the reverse is to be understood. It is also to be understood that use of the ordinal indicator “first” herein, e.g., “a first item,” should not be read as suggesting, implicitly or inherently, that there is necessarily a “second” instance, e.g., “a second item.”

Various computational elements including processors, memory, instructions, routines, models, or other components may be described or claimed as “configured to” perform a task or tasks. In such contexts, the phrase “configured to” is used to connote structure by indicating that the component includes structure (e.g., stored instructions, circuitry, etc.) that performs the task or tasks during operation. As such, the unit/circuit/component can be said to be configured to perform the task even when the specified component is not necessarily currently operational (e.g., is not on).

The components used with the “configured to” language may refer to hardware-for example, circuits, memory storing program instructions executable to implement the operation, etc. Additionally, “configured to” can refer to generic structure (e.g., generic circuitry) that is manipulated by software and/or firmware (e.g., an FPGA or a general-purpose processor executing software) to operate in manner that is capable of performing the recited task(s). Additionally, “configured to” can refer to one or more memories or memory elements storing computer executable instructions for performing the recited task(s). Such memory elements may include memory on a computer chip having processing logic. In some contexts, “configured to” may also include adapting a manufacturing process (e.g., a semiconductor fabrication facility) to fabricate devices (e.g., integrated circuits) that are adapted to implement or perform one or more tasks.

Although the foregoing embodiments have been described in some detail for purposes of clarity of understanding, it will be apparent that certain changes and modifications may be practiced within the scope of the appended claims. It should be noted that there are many alternative ways of implementing the processes, systems, and apparatus of the present embodiments. Accordingly, the present embodiments are to be considered as illustrative and not restrictive, and the embodiments are not to be limited to the details given herein.

1. A method for determining temperatures, the method comprising:
(a) applying an input signal to a first conductive element of a fabrication apparatus, the input signal having a first magnitude and a first phase;
(b) measuring an output signal at a second conductive element of the fabrication apparatus, the output signal having a second magnitude and a second phase; and
(c) determining a temperature of a region between the first conductive element and the second conductive element based at least in part on the second magnitude and the second phase.

2. The method of claim 1, wherein the first conductive element and/or the second conductive element comprises at least one of: an electrode configured to provide electrostatic clamping for a wafer undergoing processing in the fabrication apparatus; an electrode configured to provide a path for radio frequency (RF) coupling to a plasma; a wafer undergoing processing; or a heater filament.

3. The method of claim 1, wherein the input signal is within a predetermined range of a resonance frequency of a circuit formed by the first conductive element and the second conductive element.

4. The method of claim 3, wherein the resonance frequency is determined at least in part by an inductance of an inductor in series with the first conductive element or the second conductive element.

5. The method of claim 3, wherein determining the temperature of the region comprises utilizing a difference between at least one of: the second magnitude and the first magnitude; and the second phase and the first phase.

6. The method of claim 5, wherein the difference is provided as an input to a function configured to output the temperature based on the difference.

7. The method of claim 1, further comprising:
repeating (a) and (b) until a determination that the input signal is within a predetermined range of a resonance frequency of a circuit formed by the first conductive element and the second conductive element is made, wherein the determination is based at least in part on the second magnitude and the second phase associated with a given output signal; and
determining the temperature of the region based at least in part on the resonance frequency.

8. The method of claim 1, further comprising repeating (a)-(c) for at least two other conductive elements corresponding to at least one other region between the at least two other conductive elements.

9. The method of claim 1, wherein the first conductive element and/or the second conductive element is embedded in a component of the fabrication apparatus.

10. The method of claim 1, wherein the first conductive element and/or the second conductive element is affixed to a portion of the fabrication apparatus.

11. An apparatus, comprising:
a signal generator configured to apply an input signal to a first conductive element of a fabrication apparatus, the input signal having a first magnitude and a first phase; and
measurement circuitry configured to:
measure an output signal at a second conductive element of the fabrication apparatus, the output signal having a second magnitude and a second phase, and
determine a temperature of a region between the first conductive element and the second conductive element based at least in part on the second magnitude and the second phase.

12. The apparatus of claim 11, wherein the first conductive element and/or the second conductive element comprises at least one of: an electrode configured to provide electrostatic clamping for a wafer undergoing processing in the fabrication apparatus; an electrode configured to provide a path for radio frequency (RF) coupling to a plasma; a wafer undergoing processing; or a heater filament.

13. The apparatus of claim 11, wherein the input signal is within a predetermined range of a resonance frequency of a circuit formed by the first conductive element and the second conductive element.

14. The apparatus of claim 13, wherein the resonance frequency is determined at least in part by an inductance of an inductor in series with the first conductive element or the second conductive element.

15. The apparatus of claim 13, wherein determining the temperature comprises utilizing a difference between at least one of: the second magnitude and the first magnitude; and the second phase and the first phase.

16. The apparatus of claim 15, wherein the difference is provided as an input to a function configured to output the temperature based on the difference.

17. The apparatus of claim 11, wherein the first conductive element and/or the second conductive element is embedded in a component of the fabrication apparatus.

18. The apparatus of claim 17, wherein the component in which the first conductive element or the second conductive element is embedded comprises ceramic.

19. The apparatus of claim 11, wherein the first conductive element and/or the second conductive element is affixed to a portion of the fabrication apparatus.
